(19) United States
(12) Patent Application Publication
(10) Pub. No.: US 2008/0305236 A1
(43) Pub. Date: Dec. 11, 2008

(54) Beverage, Food Composition and Methods of Making Same

(76) Inventor: Lana Tatarliov, Minton (CA)

Correspondence Address: ADE & COMPANY INC., 2157 Henderson Highway, WINNIPEG, MB, R2G1P9, CA

(21) Appl. No.: 12/130,111

(22) Filed: May 30, 2008

Related U.S. Application Data
(60) Provisional application No. 60/940,716, filed on May 30, 2007.

(51) Int. Cl. A23L 2/38; A23L 1/48

(52) U.S. Cl. 426/590; 426/640

(57) ABSTRACT

A food composition, comprising a beverage or a baked good which is arranged for human consumption, is prepared using a hemp derivative, for example a fibrous material from a hemp plant, a stalk from a hemp plant, a seedless portion of a hemp plant, or an entire hemp plant. The hemp derivative is dried and ground into a suitable particulate material. The particulate material in powder like form is used to prepare a beverage by passing fluid through the prepared hemp derivative in a filter or by adding the prepared hemp derivative to a fluid mixture. A baked good is prepared by mixing the prepared hemp derivative with other ingredients to form the baked good prior to baking.

This application claims the benefit under 35 U.S.C. 119(e) of U.S. provisional application Ser. No. 60/940,716, filed May 30, 2007.

### FIELD OF THE INVENTION

The present invention relates to a beverage and a food composition comprising a hemp derivative, and more particularly relates to a method of preparing a hemp derivative for making a beverage and a food composition arranged for human consumption.

### BACKGROUND

Coffee vendors are becoming increasingly popular and the number of coffee varieties available is also increasing with the increasing popularity of the vendors. U.S. patent application publication 2006/0040039 belonging to Webb makes note of the desire for always new and different flavours of coffee. A new coffee flavouring is proposed by Webb in which hemp seeds are roasted and ground and prepared in a manner similar to coffee by passing heated water through the roasted and ground hemp seeds. While there may be some distinctness to the resulting flavour, the beverage is still formed of a similar process as compared to roasted coffee beans so that the resulting beverage is still of a similar roasted flavour variety as many coffee beverages.

### SUMMARY OF THE INVENTION

According to one aspect of the present invention there is provided a food composition arranged for human consumption comprising a plurality of ingredients, at least one of the ingredients comprising a dried, ground hemp derivative.

According to a second aspect of the present invention there is provided a method of producing a food composition for human consumption comprising:

providing at least a portion of a hemp plant;

drying said at least a portion of a hemp plant to form a dried hemp derivative;

grinding the dried hemp derivative into a particulate hemp derivative; and

mixing other food ingredients with the particulate hemp derivative to form a food mixture.

The method may further include baking the food mixture.

According to a further aspect of the present invention there is provided a beverage arranged for human consumption comprising a plurality of ingredients, at least one of the ingredients comprising a dried, ground hemp derivative.

According to another aspect of the present invention there is provided a method of producing a beverage for human consumption comprising:

providing at least a portion of a hemp plant;

drying said at least a portion of a hemp plant to form a dried hemp derivative;

grinding the dried hemp derivative into a particulate hemp derivative; and

passing hot water through the particulate hemp derivative.

The method preferably includes drying said at least a portion of a hemp plant without roasting said at least a portion of a hemp plant, that is the hemp derivative is dried substantially without heat so that it remains not roasted.

The hemp derivative preferably comprises fibrous material from a hemp plant including a stalk, a leaf, seeds or a seedless portion of a hemp plant, and more preferably comprises an entire hemp plant, in a raw, dried form prior to mixing with the other ingredients.

By using any part of a hemp plant which is prepared by drying rather than roasting and then ground, a significantly improved flavour results which is appealing for human consumption. When prepared in this fashion, the hemp derivative is also surprisingly appealing in other food compositions in addition to beverages including baked goods and the like. By drying the hemp rather than roasting, and by also using any portion of the plant rather than only the seeds, additional health benefits can be achieved which are not present in roasted seeds alone. Particularly desirable flavours and health benefits to the food composition can be achieved when the hemp derivative is formed from fibrous material of the hemp plant including the stalk, stem or leaves of the plant either with or without the seeds being included.

Some embodiments of the invention will now be described in conjunction with the accompanying drawings in which:

### BRIEF DESCRIPTION OF THE DRAWINGS

FIG. 1 is a schematic representation of the method of making a hemp containing beverage and/ or a hemp containing food composition.

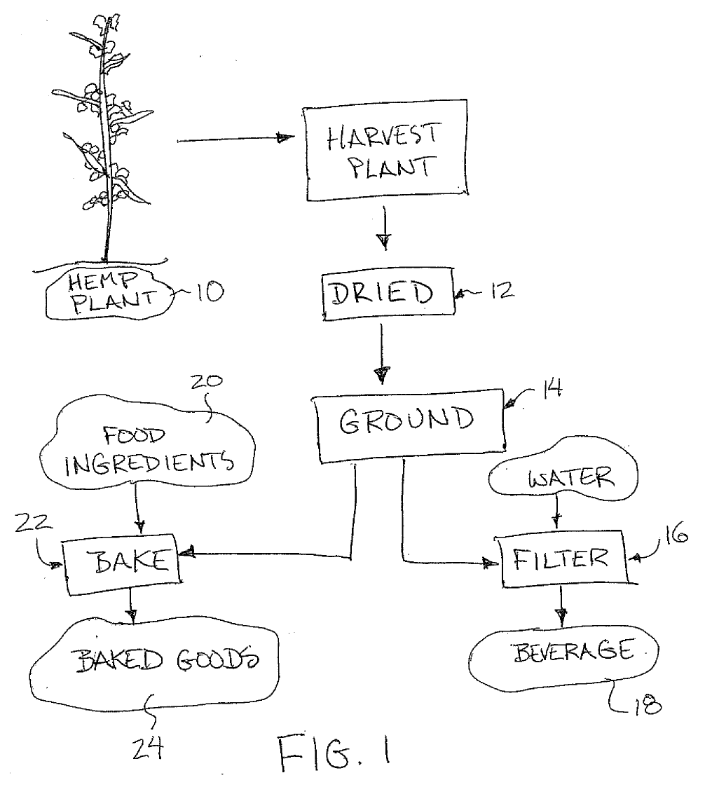

### DETAILED DESCRIPTION

Referring to the accompanying figures there is illustrated schematically a method for preparing a food composition comprising either a baked good or a beverage in which both are prepared from a similar hemp derivative.

The process begins by initially harvesting the hemp plant 10, preferably as a whole. The entire plant may be used, or alternatively the process may involve separating a particular component of the plant including the stalk or stem, the leaves or the seeds.

The portion of the hemp plant which is removed for use as a hemp derivative is then dried without excess heat, that is substantially without heat so that the resulting dried hemp derivative remains in a raw non-roasted stated.

The dried hemp derivative 12 is then ground at a following step to produce a particulate hemp derivative having a flaked or powder like consistency suitable for use in a baked good and which is similar in consistency to a ground coffee bean.

The particulate hemp derivative 14 in one embodiment can thus be received in a filter 16 similar to a coffee filter which serves to retain the larger particles of the ground particulate hemp derivative when water is passed through it so that fine particles and flavouring in solution pass through the filter and form a resulting beverage 18.

In some embodiments the particulate hemp derivative can be mixed with ground coffee beans or other suitable particulate material arranged to form a beverage when mixed with water.

In further embodiments it may also be desirable to form a beverage by mixing the particulate hemp derivative directly with the fluid of the beverage.

In an alternative embodiment the particulate hemp derivative can instead by mixed with other ingredients 20 to together form a food mixture which is suitable for baking 22. Accordingly in typical embodiments a primary one of the other ingredients mixed with the particulate hemp derivative is a flour or like product of the type used in baking. The particulate hemp derivative remains raw and unroasted prior to mixing with the other ingredients 20 and prior to baking to form the finished baked goods 24. Suitable baked goods having a desirable flavour when mixed with the particulate hemp derivative as ingredient include cookies and cakes and the like.

In further embodiments it may be desirable to roast the hemp derivative when the derivative includes either a fibrous part of the plant, a stalk portion, a leafy portion, or other seedless portion of the plant in order to vary the flavouring provided by the hemp derivative.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A food composition arranged for human consumption comprising a plurality of ingredients, at least one of the ingredients comprising a dried, ground hemp derivative.

2. The composition according to claim 1 wherein the hemp derivative comprises fibrous material from a hemp plant.

3. The composition according to claim 1 wherein the hemp derivative comprises a stalk from a hemp plant.

4. The composition according to claim 1 wherein the hemp derivative comprises a seedless portion of a hemp plant.

5. The composition according to claim 1 wherein the hemp derivative comprises an entire hemp plant.

6. The composition according to claim 1 wherein the hemp derivative comprises at least a portion of a hemp plant in a raw form prior to mixing with the other ingredients.

7. The composition according to claim 1 comprising a baked good.

8. The composition according to claim 1 comprising a beverage.

9. The composition according to claim 1 wherein the hemp derivative comprises a powder.

10. A method of producing a beverage for human consumption comprising:
providing at least a portion of a hemp plant;
drying said at least a portion of a hemp plant to form a dried hemp derivative;
grinding the dried hemp derivative into a particulate hemp derivative; and
passing hot water through the particulate hemp derivative.

11. The method according to claim 10 including drying said at least a portion of a hemp plant substantially without heating said at least a portion of a hemp plant such that said at least a portion of a hemp plant is not roasted.

12. The method according to claim 10 wherein the hemp derivative comprises fibrous material from a hemp plant.

13. The method according to claim 10 wherein the hemp derivative comprises a seedless portion of a hemp plant.

14. The method according to claim 10 wherein the hemp derivative comprises an entire hemp plant.

15. A method of producing a food composition for human consumption comprising:
providing at least a portion of a hemp plant;
drying said at least a portion of a hemp plant to form a dried hemp derivative;
grinding the dried hemp derivative into a particulate hemp derivative; and
mixing other food ingredients with the particulate hemp derivative to form a food mixture.

16. The method according to claim 15 including baking the food mixture.

17. The method according to claim 15 including drying said at least a portion of a hemp plant substantially without heating said at least a portion of a hemp plant such that said at least a portion of a hemp plant is not roasted.

18. The method according to claim 15 wherein the hemp derivative comprises fibrous material from a hemp plant.

19. The method according to claim 15 wherein the hemp derivative comprises a seedless portion of a hemp plant.

20. The method according to claim 15 wherein the hemp derivative comprises an entire hemp plant.
